(19) United States
(12) Patent Application Publication
(10) Pub. No.: US 2017/0331178 A1
(43) Pub. Date: Nov. 16, 2017

(54) WIDE BEAM ANTENNA STRUCTURE

(71) Applicant: CUBTEK INC., Hsinchu County (TW)

(72) Inventor: CHING-HAN TSAI, Hsinchu County (TW)

(21) Appl. No.: 15/590,383

(22) Filed: May 9, 2017

(30) Foreign Application Priority Data
May 10, 2016 (TW) 105206715

(51) Int. Cl. H01Q 1/32; H01Q 13/08; H01Q 1/36; H01Q 21/29

(52) U.S. Cl. CPC H01Q 1/3233; H01Q 21/293; H01Q 1/3283; H01Q 1/36; H01Q 13/08

(57) ABSTRACT

A wide beam antenna structure includes a first substrate; a second substrate disposed on a lower surface of the first substrate; a microstrip antenna layer disposed on an upper surface of the first substrate and including a plurality of microstrip antennas connected in a strip shape arrangement; a plurality of parasitic elements disposed symmetrically on two sides of the micro strip antennas with an interval therebetween, wherein the length of the parasitic element is smaller than the length of the microstrip antenna; a grounding layer disposed between the first substrate and the second substrate; and a feed line layer disposed on a lower surface of the second substrate. By use of the parasitic element to improve the half power beamwidth, the vision scope of the vehicle radar system or short distance communication operation is increased.

### BACKGROUND OF THE INVENTION

### 1. Field of the Invention

The present invention relates to antenna modules, and more particularly, to a wide beam antenna structure.

### 2. Description of the Related Art

A vehicle radar is a device with a wireless signal transceiver disposed on a vehicle bumper or inside a fan guard, so as to detect relative distance and exchange information by transmitting and receiving wireless signals. Due to a limited space applicable in the vehicle bumper and the easy attenuation property of the radar signal, an antenna array properly meeting all aspects of requirements is difficult to be provided.

A conventional vehicle radar usually applies a microstrip type array antenna, with a coupling structure minimizing the square measure thereof. However, the operation bandwidth of the vehicle radar system ranges from 24 GHz to 77 GHz, while an improvement upon the antenna performance for further enhancing the antenna gain in such a high frequency range is difficult to be achieved. Therefore, it is desired for the industry to effectively enhance the antenna array gain, minimize the square measure necessary for the antenna, and optimize the antenna radiation pattern.

### SUMMARY OF THE INVENTION

For improving the issues above, a wide beam antenna structure is disclosed. By use of the parasitic element to improve the half power beamwidth, the vision scope of the vehicle radar system or short distance communication operation is increased.

For achieving the abovementioned objectives, a wide beam antenna structure in accordance with an embodiment of the present invention is provided, comprising:

a first substrate provided with an upper surface and a lower surface;

a second substrate disposed on the lower surface of the first substrate and provided with an upper surface and a lower surface;

a microstrip antenna layer disposed on the upper surface of the first substrate and including a plurality of microstrip antennas connected in a strip shape arrangement;

a plurality of parasitic elements disposed symmetrically on two sides of the microstrip antennas with an interval between each parasitic element and the corresponding microstrip antenna, wherein a length of the parasitic element is smaller than a length of the micro strip antenna;

a grounding layer disposed on the upper surface of the second substrate and positioned between the first substrate and the second substrate; and

a feed line layer disposed on the lower surface of the second substrate.

### BRIEF DESCRIPTION OF THE DRAWINGS

FIG. 1 is a partially sectional view of the wide beam antenna structure in accordance with an embodiment of the present invention.

FIG. 2 is a partial top view of the wide beam antenna structure.

FIG. 3 is a diagram illustrating the relationship between the interval, which exists between the parasitic element and the microstrip antenna, and the antenna gain of the wide beam antenna structure.

FIG. 4 is a simulation diagram of the antenna radiation pattern of the wide beam antenna structure.

FIG. 5 is a diagram illustrating the relationship between the length of the parasitic element and the antenna gain of the wide beam antenna structure in accordance with another embodiment of the present invention.

FIG. 6 is a diagram illustrating the relationship between the width of the parasitic element and the antenna gain of the wide beam antenna structure in accordance with another embodiment of the present invention.

FIG. 7 is a simulation diagram of the antenna radiation pattern of the wide beam antenna structure embodiment of FIG. 6.

FIG. 8 is a simulation diagram of the reflection coefficients of the wide beam antenna structure provided with the parasitic element in accordance with another embodiment of the present invention.

FIG. 9(a) to FIG. 9(e) are diagrams illustrating the pattern of the embodiment of FIG. 8 at a frequency of 77 GHz, 78 GHz, 79 GHz, 80 GHz, and 81 GHz, respectively.

FIG. 10 is a schematic view illustrating the wide beam antenna structure in accordance with another embodiment of the present invention.

FIG. 11(a) to FIG. 11 (e) are diagrams illustrating the pattern of the embodiment of FIG. 10 at a frequency of 77 GHz, 78 GHz, 79 GHz, 80 GHz, and 81 GHz, respectively.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion. For the briefness of the drawings, unrelated details are not shown. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features. Certain details of technical features are allowed to be omitted. Also, certain common steps or elements are not included in the specification for avoiding unnecessary limitations. Further, identical or similar components in the drawings are marked with identical or similar numeric.

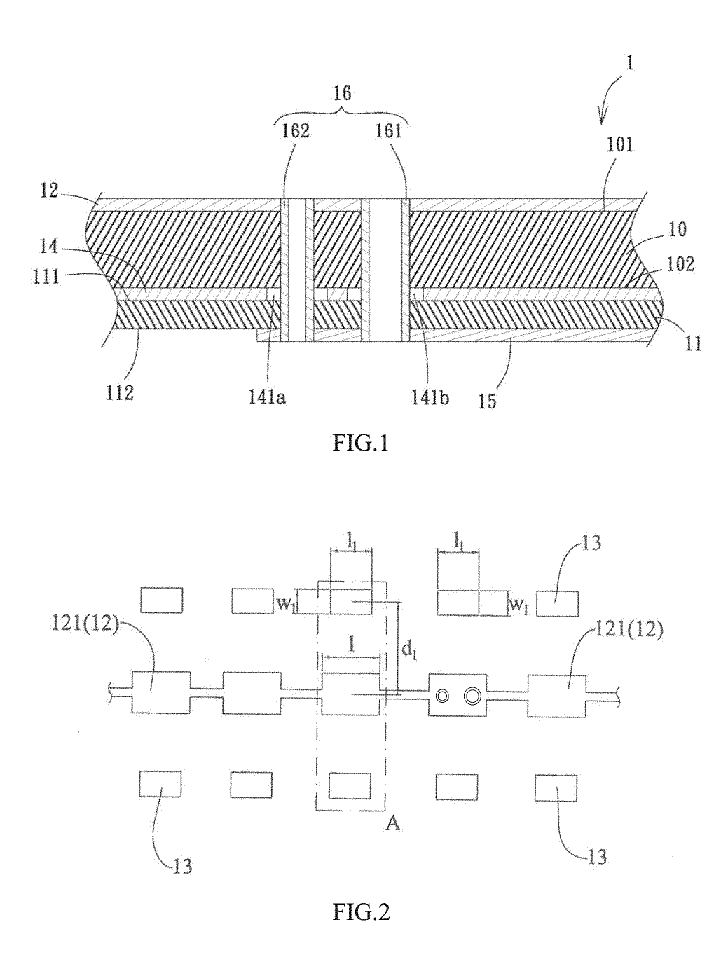

FIG. 1 and FIG. 2 are a partially sectional view and a partial top view illustrating a wide beam antenna structure 1 in accordance with an embodiment of the present invention. As shown by FIG. 1 and FIG. 2, the wide beam antenna structure 1 comprises a first substrate 10, a second substrate 11, a microstrip antenna layer 12, a plurality of parasitic elements 13, a grounding layer 14, and a feed line layer 15. The microstrip antenna layer 12 is disposed on an upper surface 101 of the first substrate 10 and provided with a plurality of micro strip antennas 121 that are connected in a strip shape arrangement. As shown by FIG. 2, the microstrip antennas 121 are connected in a strip shape array arrangement. The parasitic elements 13 are disposed symmetrically on, but not limited to, two sides of the microstrip antennas 121, with an interval D₁ between each parasitic element 13 and the corresponding microstrip antenna 121. The length L₁ of the parasitic element 13 is smaller than the length L of the microstrip antenna 121. The grounding layer 14 is disposed on an upper surface 111 of the second substrate 11 and positioned between the first substrate 10 and the second substrate 11. As shown by FIG. 1, the feed line layer 15 is disposed on a lower surface 112 of the second substrate 11 for feeding a wireless signal to the antenna structure 1. In an embodiment, a conductive pillar set 16 is disposed on the microstrip antennas 121, wherein the conductive pillar set 16 penetrates the first substrate 10 and the second substrate 11 for electrically connecting the feed line layer 15 and the microstrip antenna layer 12. In a preferred embodiment, the conductive pillar set 16 includes a first pillar 161 and a second pillar 162 that are disposed with an interval therebetween, wherein the size of the first pillar 161 is different from the size of the second pillar 162. In the embodiment, the size thereof refers to the radius of the pillars. Further, the grounding layer 14 is provided with through holes 141a and 141b whose diameter is larger than the outer diameter of the first pillar 161 and the second pillar 162, such that the first pillar 161 and the second pillar 162 are allowed to pass through the through holes 141a, 141b. Alternately, the through holes 141a, 141b are able to be provided with insulating material, so as to prevent the first pillar 161 and the second pillar 162 from communicating with the grounding layer 14.

In an embodiment of the present invention, an interval D₁ between the parasitic element 13 and the corresponding microstrip antenna 121 ranges from 0.5 to 2 mm. The width W₁ of the parasitic element 13 ranges from 0.7 to 1.2 mm. In another embodiment, the length L₁ of the parasitic element 13 ranges from 0.2 to 0.6 mm. The effects achieved by the interval between the parasitic element 13 and the microstrip antenna 121 and the width and length of the parasitic element 13 are explained below.

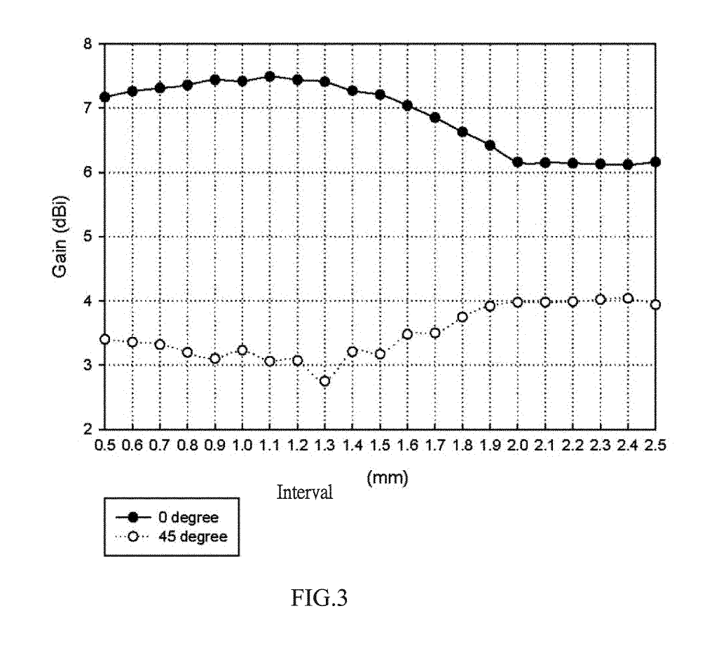

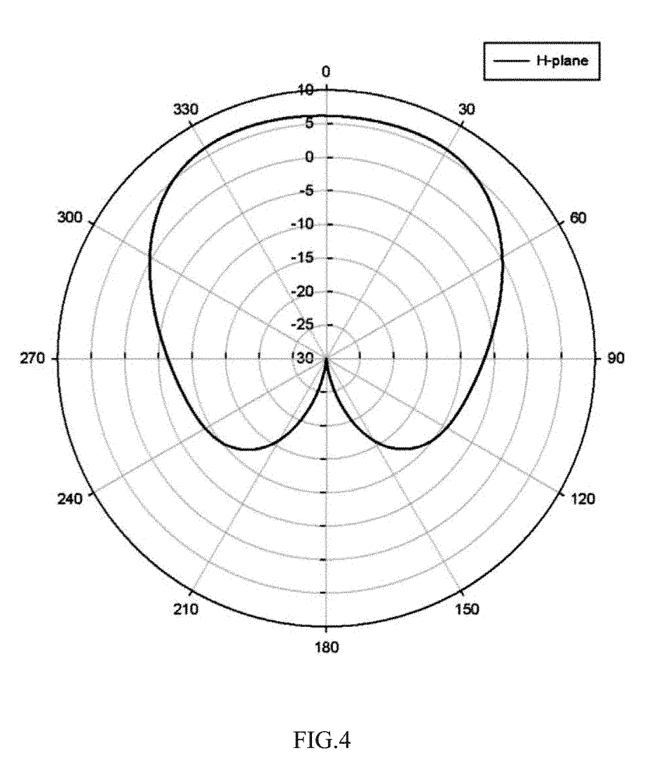

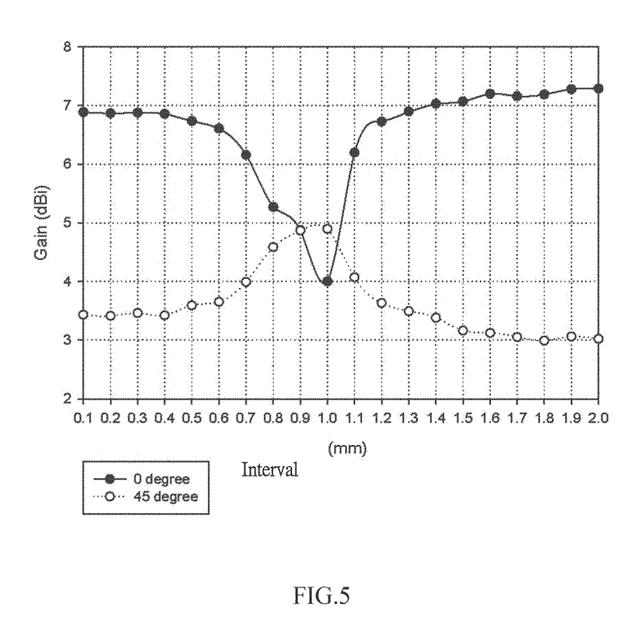

Regarding the effect caused by the distance between the parasitic element 13 and a single microstrip antenna 121 upon the beamwidth of the antenna unit, the example is illustrated as the dotted-line frame A in FIG. 2. In one embodiment, the length L₁ of the parasitic element 13 is 0.7 mm, and the width W₁ of the parasitic element 13 is 0.1 mm. Referring to FIG. 3 which illustrates the antenna gain corresponding to different intervals D₁, it is shown in the chart that when the interval D₁ between the parasitic element 13 and the microstrip antenna 121 is smaller than 1.1 mm, the 0 degree antenna gain on H-plane (horizontal) gradually rises, while the 45 degree antenna gain gradually lowers. When the interval D₁ is between 1.1 to 2 mm, the 0 degree antenna gain gradually lowers, while the 45 degree antenna gain gradually rises. When the interval D₁ is larger than 2 mm, both gains almost remain in a stable value. The reason possibly lies in that if the distance between the parasitic element 13 and the microstrip antenna 121 is relatively small, current on the parasitic element 13 is almost in a same phase with the current on the microstrip antenna 121, such that the gain along the E-plane (vertical) is increased and the 45 degree antenna gain becomes lower with a narrower beamwidth. When the interval increases, the phase difference is enlarged, such that the beam biases toward upper and lower sides, causing the beamwidth to become wider. However, due to the fact that the coupling amount become smaller along with the variation of the distance, the effect imposed by the parasitic element 13 upon the radiation pattern becomes unobvious when the interval D₁ reaches a certain degree. FIG. 4 is a simulation diagram of the antenna radiation pattern on H-plane (horizontal) when the interval D1 reaches 2 mm, wherein the 0 degree antenna gain is 6.16 dBi and the 45 degree antenna gain is 4.16 dBi.

Regarding the effect imposed by the length L₁ of the parasitic element 13 upon the antenna gain, in another embodiment, the interval D₁ is fixed at 2 mm. Referring to FIG. 5, it is shown that when the interval D₁ is between 0.7 to 1.1 mm, the 0 degree and 45 degree antenna gain vary in a great level. The reason lies in that the parasitic element 13 now acts as a direction pointing device, such that the beam is biased toward upper and lower sides.

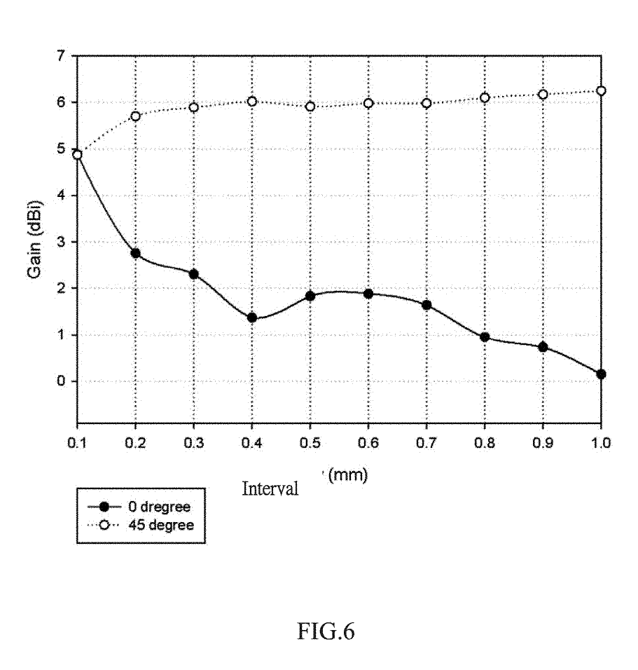

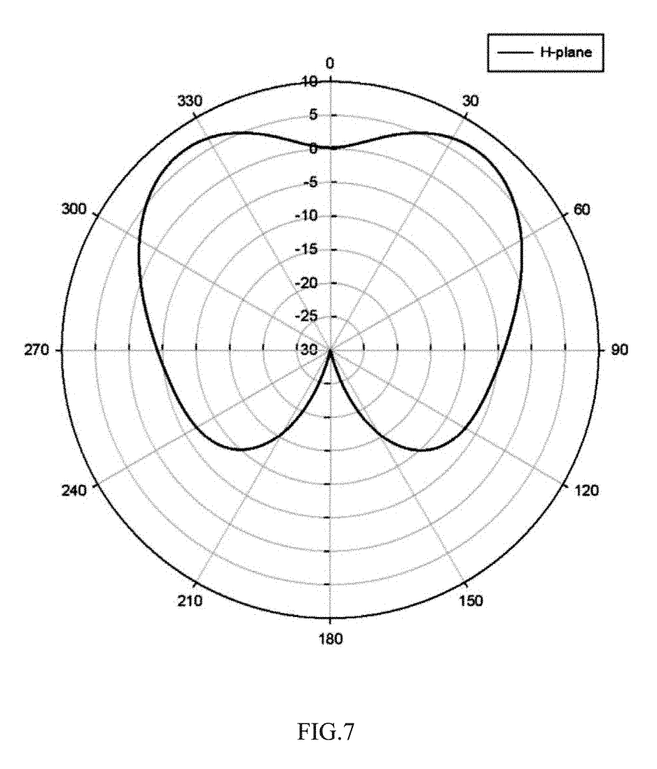

Further, regarding the effect imposed by the width W₁ of the parasitic element 13 upon the antenna gain, in another embodiment, the length L₁ of the parasitic element 13 is 0.9 mm. Referring to FIG. 6, when the width is increased, the coupling amount is enlarged, and the biasing of the beam toward upper and lower sides becomes obvious, such that the 0 degree antenna gain is lowered, while the 45 degree antenna gain only varies in a small level. FIG. 7 is a simulation diagram of the antenna radiation pattern on H-plane (horizontal) when the width W₁ of the parasitic element 13 is 1 mm.

Accordingly, the distance of the interval between the parasitic element 13 and the microstrip antenna 121 imposes effects upon the phase difference between the parasitic element 13 and the microstrip antenna 121; the length of the parasitic element 13 imposes effects upon the wave guiding property of the parasitic element 13, and the width of the parasitic element 13 imposes effects upon the coupling amount. Thus, by adjusting such parameters, a wider beamwidth of antenna is achieved.

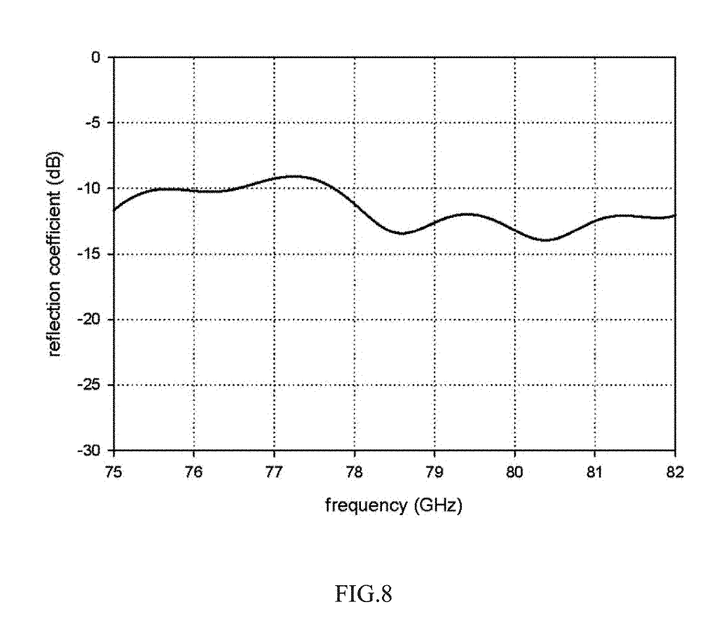

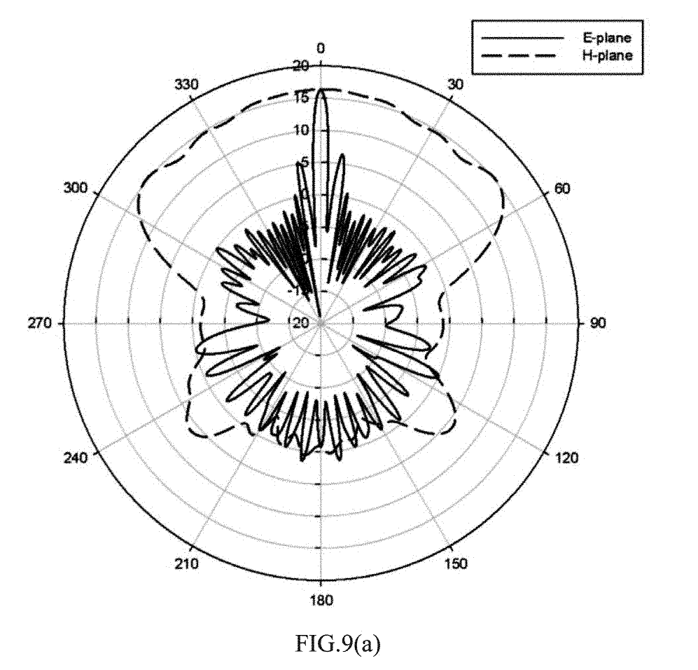

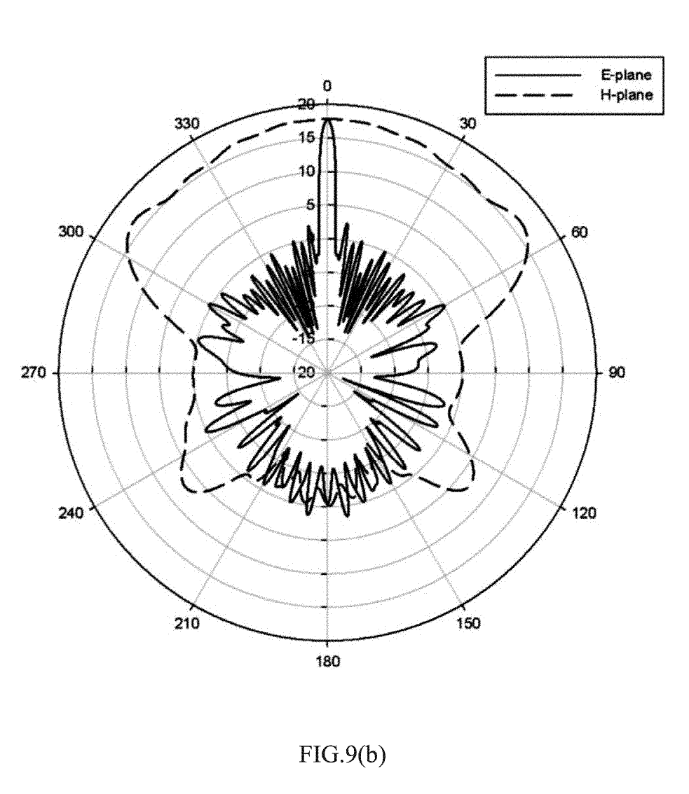

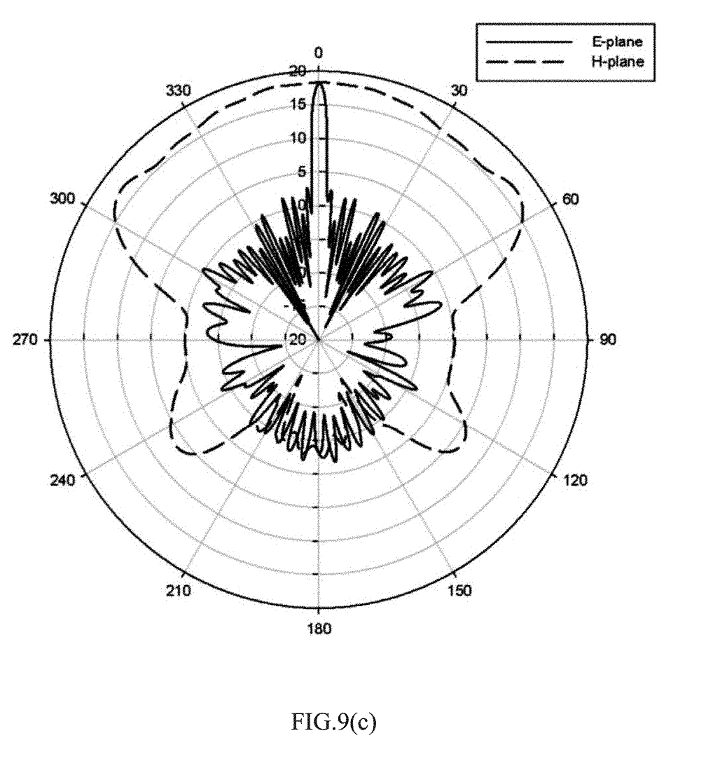

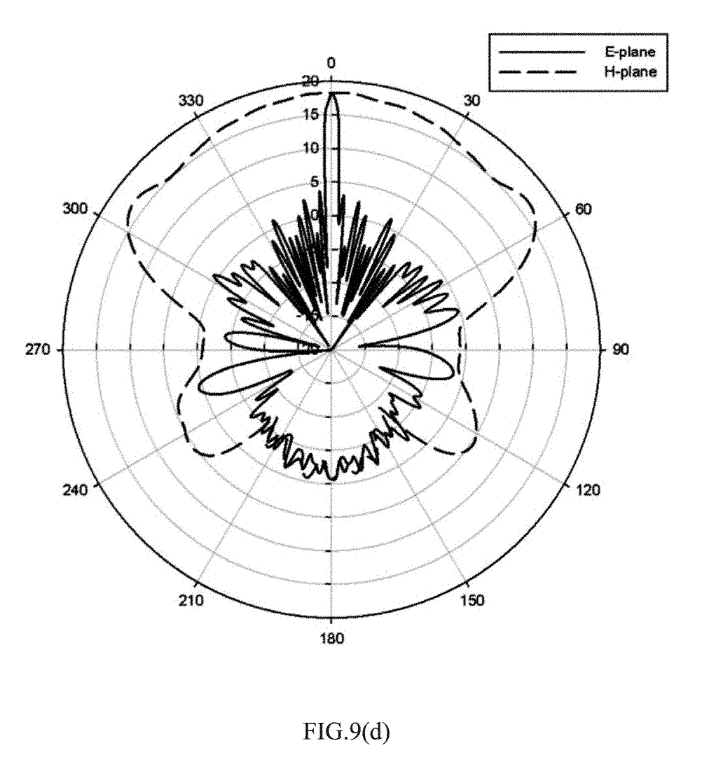

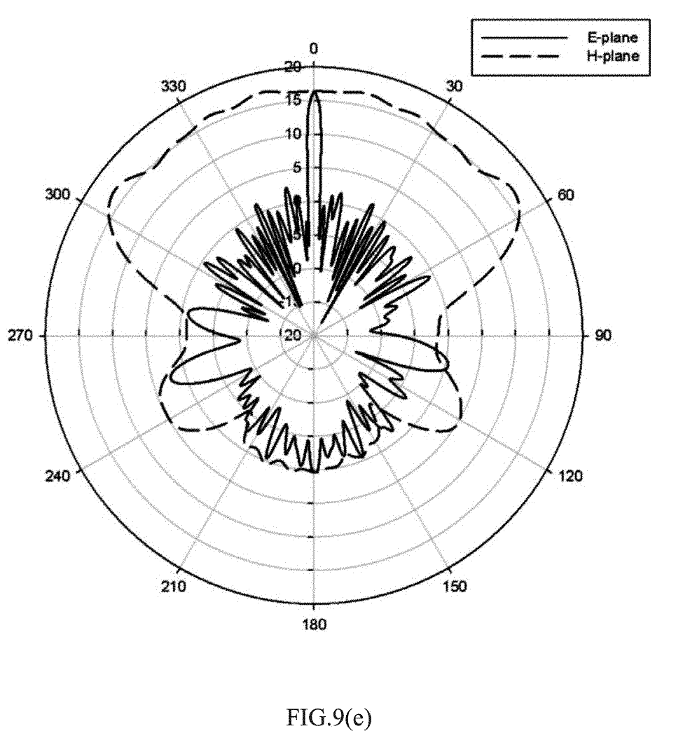

In an embodiment, the parasitic elements 13 are disposed in a wideband array. Referring to FIG. 2, when the total length of the antenna is 63 mm, and the interval D₁ between the parasitic element 13 and the microstrip antenna 121 is 2.2 mm, while the length L₁ of the parasitic element 13 is 0.7 mm and the width W₁ of the parasitic element 13 is 0.5 mm, the acquired reflection coefficients are shown as FIG. 8, wherein the acquired result does not significantly differ from the result acquired from a microstrip array antenna without parasitic elements 13. Therefore, the parasitic element 13 does not greatly affect the impedance matching result. FIG. 9(a) to FIG. 9(e) illustrate the simulation diagram of radiation patterns at a frequency of 77 GHz, 78 GHz, 79 GHz, 80 GHz, and 81 GHz, respectively. It is understood that, at a frequency from 77 to 81 GHz, the beam on H-plane (horizontal) becomes wider, while the beam on E-plane (vertical) does not significantly vary. The gain effects are shown in Table 1.

TABLE 1

| | frequency | | | | |
|---|---|---|---|---|---|
| gain | 77 GHz | 78 GHz | 79 GHz | 80 GHz | 81 GHz |
| 0 degree | 14.64 dBi | 16.24 dBi | 17.07 dBi | 16.98 dBi | 16.40 dBi |
| 45 degree | 15.34 dBi | 17.40 dBi | 16.55 dBi | 15.92 dBi | 14.69 dBi |
| −45 degree | 15.32 dBi | 17.38 dBi | 16.53 dBi | 15.91 dBi | 14.69 dBi |

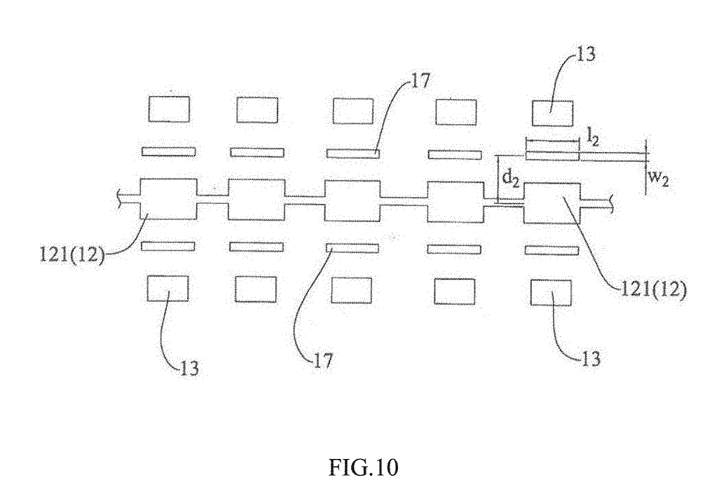

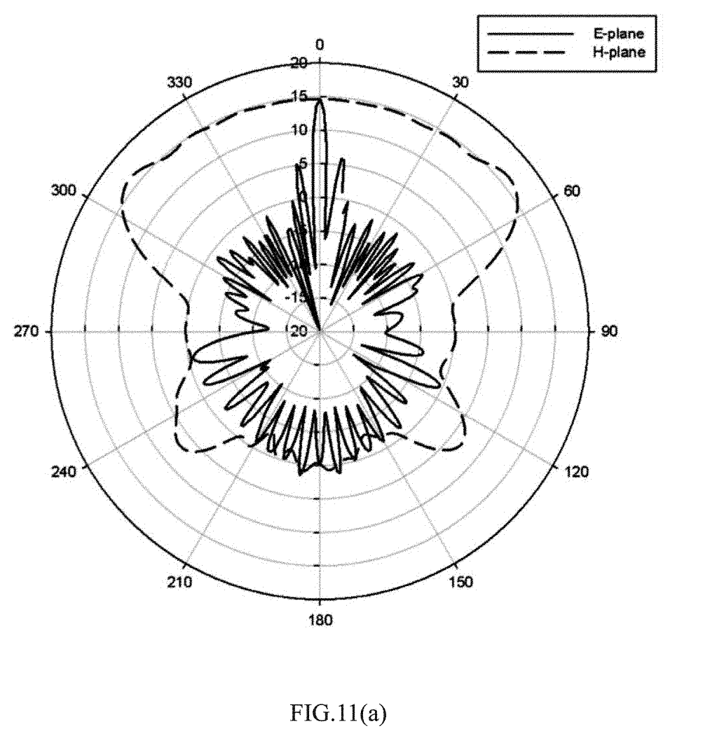

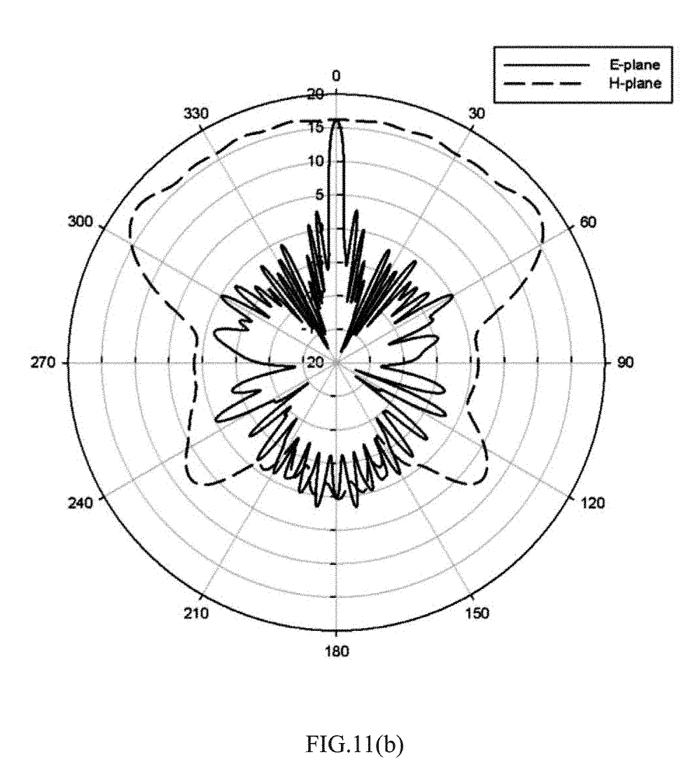

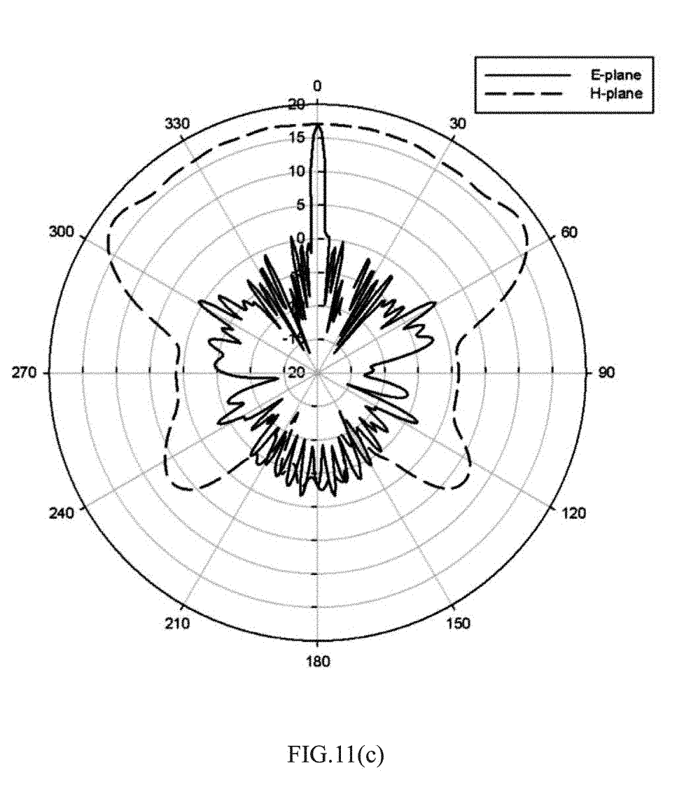

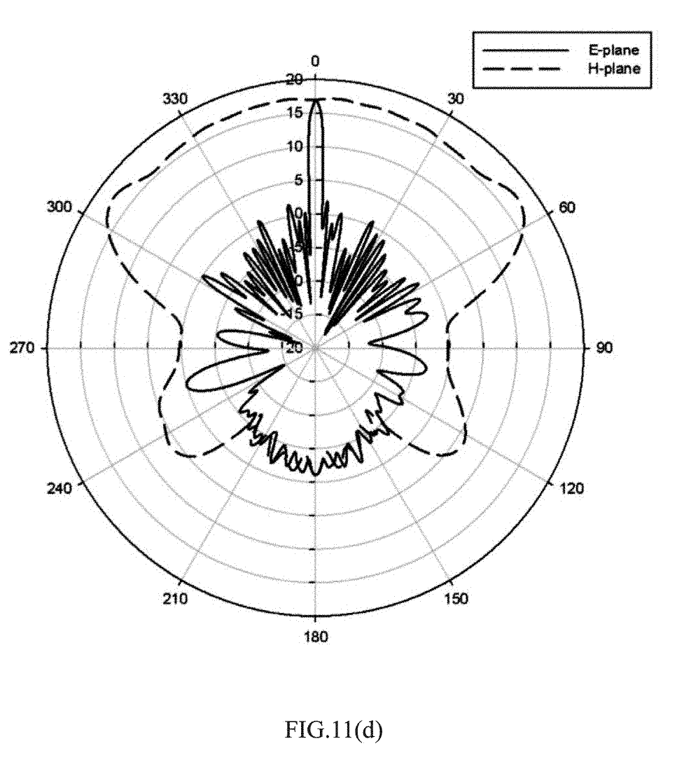

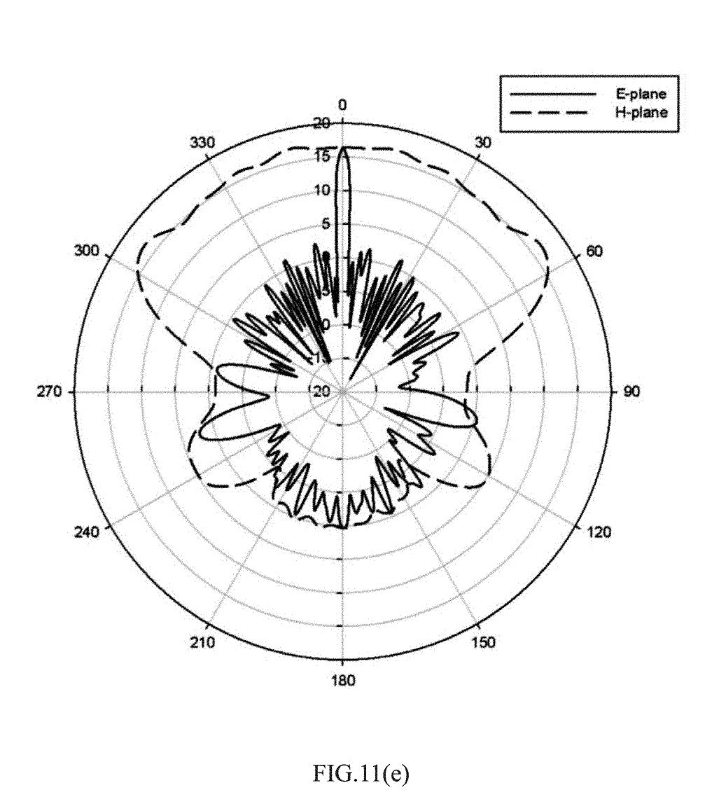

In another embodiment, the wide beam antenna structure 1 further includes a plurality of open grooves 17 disposed between the parasitic elements 13 and the microstrip antennas 121, as shown by FIG. 10. In this embodiment, the length L₂ of the open groove 17 is 1 mm, and the width W₂ of the open groove 17 is 0.1 mm, while the interval D₂ between the open groove 17 and the microstrip antenna 121 is 1 mm. The simulation diagrams of radiation patterns at each frequency are shown by FIG. 11(a) to FIG. 11(e) representing the patterns at 77 to 81 GHz, respectively. The gain effects are shown by Table 2.

TABLE 2

| | frequency | | | | |
|---|---|---|---|---|---|
| gain | 77 GHz | 78 GHz | 79 GHz | 80 GHz | 81 GHz |
| 0 degree | 15.98 dBi | 16.92 dBi | 17.17 dBi | 16.92 dBi | 15.83 dBi |
| 45 degree | 16.70 dBi | 17.51 dBi | 17.55 dBi | 17.20 dBi | 16.13 dBi |
| −45 degree | 16.76 dBi | 17.57 dBi | 17.60 dBi | 17.27 dBi | 16.18 dBi |

Referring to the statistics from the two embodiments above, it is shown that the specific dispositions of the parasitic elements 13 results in a great effect regarding expanding the radiation beam of the antenna structure 1.

To sum up, by use of the parasitic element to improve the half power beamwidth through guiding the electromagnetic wave toward the waving direction of the parasitic elements, the vision scope of the vehicle radar system or short distance communication operation is increased. Also, by adding the conductive pillar set or open grooves into the antenna structure according to different user demands, the antenna structure is allowed to achieve reverse-feeding and power dividing functions.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wide beam antenna structure, comprising:
a first substrate provided with an upper surface and a lower surface;
a second substrate disposed on the lower surface of the first substrate and provided with an upper surface and a lower surface;
a microstrip antenna layer disposed on the upper surface of the first substrate and including a plurality of microstrip antennas connected in a strip shape arrangement;
a plurality of parasitic elements disposed symmetrically on two sides of the microstrip antennas with an interval between each parasitic element and the corresponding microstrip antenna, wherein a length of the parasitic element is smaller than a length of the microstrip antenna;
a grounding layer disposed on the upper surface of the second substrate and positioned between the first substrate and the second substrate; and
a feed line layer disposed on the lower surface of the second substrate.

2. The antenna structure of claim 1, wherein a conductive pillar set is disposed on the microstrip antenna and penetrates the first substrate and the second substrate, so as to electrically connect the feed line layer and the microstrip antenna layer.

3. The antenna structure of claim 2, wherein the conductive pillar set includes a first pillar and a second pillar, wherein a size of the first pillar is different from a size of the second pillar.

4. The antenna structure of claim 1, wherein a width of the parasitic element ranges from 0.2 to 0.6 mm.

5. The antenna structure of claim 1, wherein a length of the parasitic element ranges from 0.7 to 1.2 mm.

6. The antenna structure of claim 1, wherein the interval between the parasitic element and the corresponding microstrip antenna ranges from 0.5 to 2 mm.

7. The antenna structure of claim 1, further comprising a plurality of open grooves disposed between the parasitic element and the corresponding microstrip antenna, respectively.
